(19) United States
(12) Patent Application Publication
(10) Pub. No.: US 2010/0274793 A1
(43) Pub. Date: Oct. 28, 2010

(54) METHOD AND APPARATUS OF CONFIGURING FOR SERVICES BASED ON DOCUMENT FLOWS

(75) Inventors: Oskari Koskimies, Helsinki (FI); Anssi Kalevi Karhinen, Vantaa (FI)

Correspondence Address: DITTHAVONG MORI & STEINER, P.C., 918 Prince Street, Alexandria, VA, 22314, US

(73) Assignee: Nokia Corporation, Espoo (FI)

(21) Appl. No.: 12/430,725

(22) Filed: Apr. 27, 2009

(51) Int. Cl. G06F 17/30

(52) U.S. Cl. 707/754; 707/E17.044; 707/E17.008; 707/E17.109

(57) ABSTRACT

An approach is provided for a small footprint, flexible client process for a document-flow based service on a mobile device. The approach includes initiating modification of a metadata extraction rule based on configuration data. Metadata is extracted from a document received in a message using the modified extraction rule,

### BACKGROUND

Given that service providers are continually challenged to deliver new and sophisticated applications, such demand can place significant resource strain on end user devices. For instance, generic service platforms have emerged to provide robust services to the end users. However, this variety is achieved at a cost to the end devices, particularly in a mobile environment where resources are constrained. For example, many mobile nodes are small devices with limited screen space and processing power; and are heavily burdened by a large number of client applications.

### SOME EXAMPLE EMBODIMENTS

Therefore, there is a need for a flexible, small-footprint client that can be configured dynamically for any document-based distributed process flow on a network.

According to one embodiment, an apparatus comprises a processor and a memory storing executable instructions that if executed cause the apparatus to initiate modification of a metadata extraction rule based on configuration data, and extract metadata from a document received in a message using the modified extraction rule.

According to another embodiment, an apparatus comprises means for initiating modification of a metadata extraction rule based on configuration data, and means for extracting metadata from a document received in a message using the modified extraction rule.

According to another embodiment, a computer-readable storage medium carries instructions which, when executed by a processor, cause an apparatus to at least perform initiating modification of a metadata extraction rule based on configuration data, and extracting metadata from a document received in a message using the modified extraction rule.

According to another embodiment, a method comprises transmitting a configuration document that holds configuration data for modifying a metadata extraction rule for extracting metadata from a document for a document-flow based service. The method also comprises transmitting a message that comprises a document that comprises the metadata for the document-flow based service.

According to another embodiment, an apparatus comprises means for transmitting a configuration document that holds configuration data for modifying a metadata extraction rule for extracting metadata from a document for a document-flow based service. The apparatus also comprises means for transmitting a message that comprises a document that comprises the metadata for the document-flow based service.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings, in which:

FIG. 1 is a diagram of a document for a document-flow based service, according to one embodiment;

FIG. 2 is a diagram of document flow for a document-flow based service, according to one embodiment;

FIG. 3 is a diagram of a document metadata and business data, according to one embodiment;

FIG. 4 is a diagram of a document flow for a document-flow based travel service in an organization, according to one embodiment;

FIG. 5A is a diagram of component modules for a small footprint, flexible client side module for a document-flow based service, according to an embodiment;

FIG. 5B is a diagram of a screen presented by the Main UI module, according to an embodiment;

FIG. 6 is a diagram of relationships among data objects for the client side module and a document for a document-flow based service, according to an embodiment;

FIG. 7A is a diagram of the configuration data for each service, according to an embodiment;

FIG. 7B is a diagram of folder fields for one folder, according to an embodiment;

FIG. 8A and FIG. 8B are flowcharts of a client side process to handle a document for a document-flow based service, according to one embodiment;

FIG. 9 is a diagram of hardware that can be used to implement an embodiment of the invention;

FIG. 10 is a diagram of a chip set that can be used to implement an embodiment of the invention; and

FIG. 11 is a diagram of a terminal that can be used to implement an embodiment of the invention.

### DETAILED DESCRIPTION OF EXAMPLE EMBODIMENTS

A method, apparatus, and software are disclosed for providing configurable client process services based on document-flows. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Although several embodiments of the invention are discussed with respect to a travel service based on document flows of extended markup language (XML) documents, embodiments of the invention are not limited to this context. It is explicitly anticipated that in other embodiments, the same or other formats for digital data representation of documents including information to be presented to a human user are used for the same or different document-flow based services over any combination of one or multiple networks including local area networks, wide area networks, virtual private networks, and the public Internet.

FIG. 1 is a diagram of a document 102 for a document-flow based service, according to one embodiment. By way of example, in a distributed process implemented on a network with mobile nodes, metadata about the state of the process is included in each document sent between nodes of the network. Each node is responsible for displaying the documents available on the node, indicating the state of processing associated with each document, and permitting suitable actions on the document, including forwarding to a different node in the network. The appropriate display and allowed actions at a node, however, depend on the actual process, the current state of the document and the role of a user of the node with respect to the process. Thus, the node must be configured to properly display and allow appropriate actions on each document for each process. The node is typically configured by installing different client side software on each node for each different process in which the node participates.

The document 102 includes, for example, business data 116 that indicates information to be understood, changed or acted upon by a human viewer and metadata 118 that describes the document for proper automated handling and management. In general, metadata comprises data representing values in one or more data fields corresponding to metadata parameters. In an XML document, the data field name, e.g., the metadata parameter name, is included with the corresponding value for the field, both often expressed as character strings. As used herein, business data 116 refers to any data for human use, no matter the application. Thus a document-flow based service can be used for business applications such as customer orders and internal enterprise management functions, like a travel service, as well as non-business applications, such as patient and medical services, engineering design and approval services, legal services, and academic processes such as course registration and manuscript preparation, among others.

In a centralized system, task management process state can be tracked by a central server. Clients can update the state on the central server, and state changes can be quickly made visible to everyone who is online. In a distributed document flow system, a distributed solution that fits with a messaging-based communication paradigm is desirable. Such a distributed solution may also support offline use, e.g., targeted for mobile users with limited or intermittent network connectivity, or who may exchange data through direct/proximity data exchanges outside of a formal network.

By way of example, the document 102 can be used to initiate, record, formalize, track, and/or notify parties about aspects of processes (e.g., business or workflow processes), including tasks, entities, individuals, tangible/intangible assets, projects, contracts, events, services, etc. In a document flow framework described herein, task management can be handled by organizing documents into “threads,” where each thread corresponds to a process. In the past, the concept of threads has been associated with email exchanges, online message boards, text message exchanges, Usenet groups, etc. In those types of communications, ongoing communications are grouped into threads according to a particular message or subject. The communications may be presented in some order (e.g., sorted by time created/received) and may be hierarchically arranged based on other factors (e.g., responses to a particular message may be grouped beneath the originally posted message).

As such term is used generally herein, threads are a data paradigm used to illustrate states and relationships of ongoing transactions. For example, the term “thread” may refer to data/executable objects that reside in user devices that reflect states of the underlying transactions. This thread object may also have a visual presentation component. The ongoing transactions represented by threads may include transfer of documents, tangible assets, written or verbal communications, etc. Further, the processes that are represented by threads need not be associated with for profit entities. Therefore, although example “business processes” may be described herein in terms of business organizations, those of skill in the art will appreciated that a “process” or “business process” may include any form of tasks utilizing electronic message exchanges that collectively accomplish a defined goal in an orderly fashion. For example, common tasks performed by individuals, such as organizing a party, fundraising, community awareness, circulating petitions, etc., may involved exchanges that could be tracked via electronic messaging and represented as threads to participants.

In one embodiment, a document thread may have a state which describes the current overall state of the business process, e.g. “Order sent,” “Delivery received,” etc. Sub-processes can be represented as nested threads. A user interface that represents documents as threads may be sufficiently close to email to give users an intuitive understanding of how to use it. However, such a system may exhibit differences from standard email. For example, standard email may not support the full metadata needed to manage the document-flow based service or adapt well to different services.

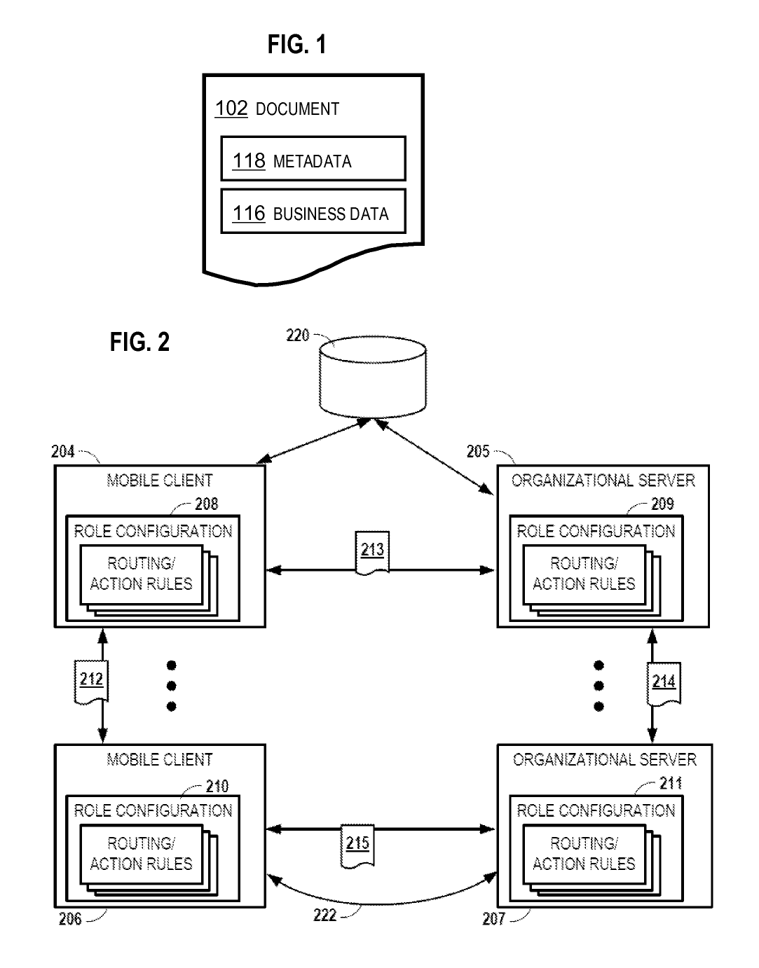

FIG. 2 is a diagram of document flow for a document-flow based service, according to one embodiment. The illustrated embodiment includes communication flows in a distributed mobile document system. The participants of the flow communicate by sending documents (e.g., document 102) to each other. The communication nodes (e.g., mobile clients 204, 206 and servers 205, 207) may be “store-and-forward” type processing nodes that facilitate easy and intuitive operation in difficult connectivity conditions. The nodes 204, 205, 206, 207 include respective role configuration modules 208, 209, 210, 211 that each maintain and apply metadata extraction/display/routing/action rules for processing and routing various documents 212-215 that circulate through the system.

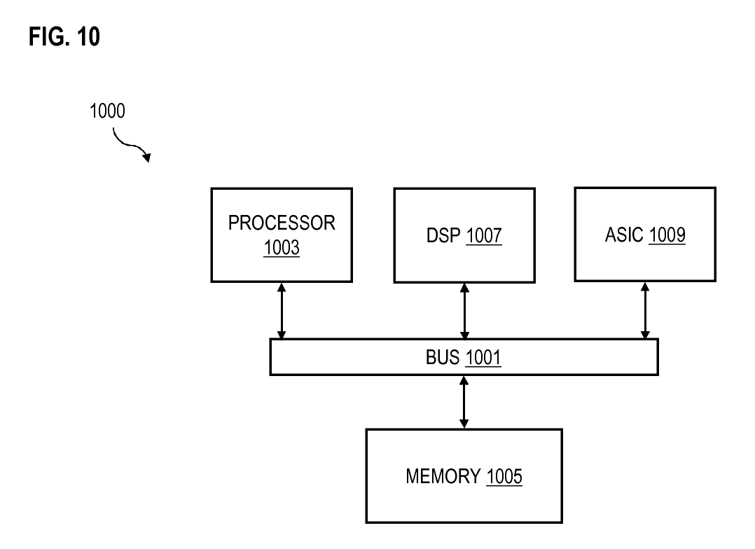

In various embodiments, nodes 204 to 207 can be any type of fixed terminal, mobile terminal, or portable terminal including desktop computers, laptop computers, handsets, stations, units, devices, multimedia tablets, Internet nodes, communicators, Personal Digital Assistants (PDAs), mobile phones, mobile communication devices, audio/video players, digital cameras/camcorders, televisions, digital video recorders, game devices, positioning devices, or any combination thereof. Moreover, the nodes may have a hard-wired energy source (e.g., a plug-in power adapter), a limited energy source (e.g., a battery), or both. It is further contemplated that the nodes 204 to 207 can support any type of interface to the user (such as “wearable” circuitry, etc.). In the illustrated embodiment, nodes 204 and 206 are wireless mobile terminals (each also called a mobile station and described in more detail below with reference to FIG. 10). The mobile terminals 204 and 206 are connected to a communications network by wireless links.

Communications among nodes 204 to 207 are accomplished over a network (not shown). By way of example, the communication network can include one or more wired and/or wireless networks such as a data network (not shown), a wireless network (not shown), a telephony network (not shown), or any combination thereof, each comprised of zero or more nodes. It is contemplated that the data network may be any local area network (LAN), metropolitan area network (MAN), wide area network (WAN), the Internet, or any other suitable packet-switched network, such as a commercially owned, proprietary packet-switched network, e.g., a proprietary cable or fiber-optic network, or any combination thereof. In addition, the wireless network may be, for example, a cellular network and may employ various technologies including code division multiple access (CDMA), wideband code division multiple access (WCDMA), enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, wireless fidelity (WiFi), satellite, and the like. In various embodiments, communication network 105, or portions thereof, can support communication using any protocol, for example, the Internet Protocol (IP).

Information is exchanged between network nodes 204-207 according to one or more of many protocols (including, e.g., known and standardized protocols). In this context, a protocol includes a set of rules defining how the nodes interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model. The OSI Reference Model is generally described in more detail in Section 1.1 of the reference book entitled “Interconnections Second Edition,” by Radia Perlman, published September 1999.

The client-server model of computer process interaction is widely known and used. According to the client-server model, a client process sends a message including a request to a server process, and the server process responds by providing a service. The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others. A well known client process available on most nodes connected to a communications network is a World Wide Web client (called a “web browser,” or simply “browser”) that interacts through messages formatted according to the hypertext transfer protocol (HTTP) with any of a large number of servers called World Wide Web servers that provide web pages.

Another way that the workflow state data can be distributed is by embedding identifiers (e.g., Uniform Resource Locators, URLs, user identities, messaging addresses) of participants in the workflow. These participant identifiers could be attached with portions of the metadata, such that only particular changes to document/task/thread state will be communicated based on, for example, the role of the participant in the business flow. This state data could be communicated using out of band mechanisms (e.g., mechanisms that are independent of those used to communicate documents 212-215), as indicated by alternate data path 222 between client 206 and server 207.

These out of band mechanisms 222 may be supplementary to the embedding of data in electronic documents. The participant may be able to determine and/or affect metadata stored elsewhere (e.g., in repository 220) that is associated with an electronic version of a paper document. In such a case, other electronic documents in the process may include a reference to the repository 220 embedded in the metadata, so that interested parties can retrieve thread states related to documents no on the user's node.

Although a particular set of nodes, processes, and data structures are shown in FIG. 2 for purposes of illustration, in various other embodiments more or fewer nodes, processes and data structures are involved. Furthermore, although processes and data structures are depicted as particular blocks in a particular arrangement for purposes of illustration, in other embodiments each process or data structure, or portions thereof, may be separated or combined or arranged in some other fashion.

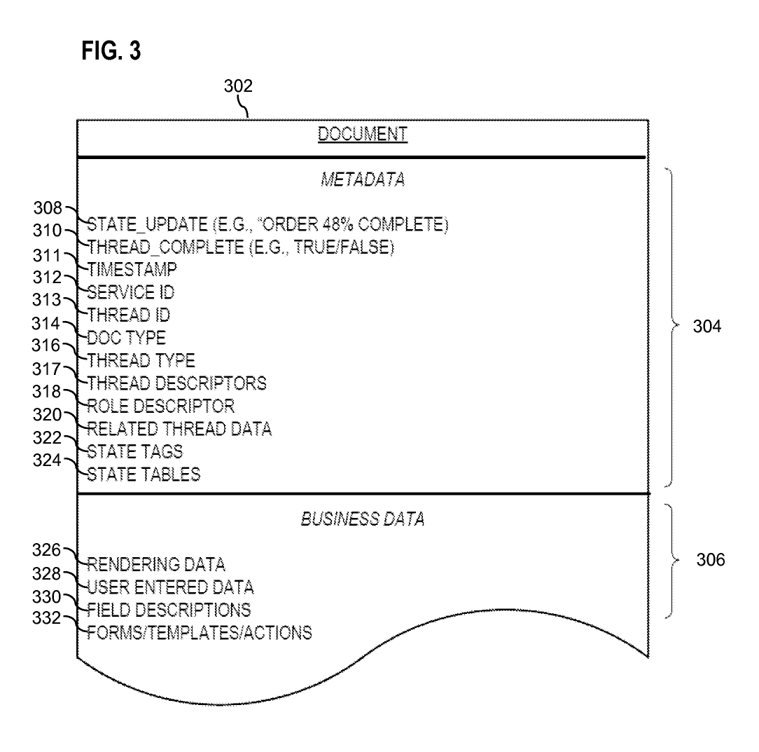

FIG. 3 is a diagram of a document metadata and business data, according to one embodiment. The document 302 includes metadata 304 and business data 306.

Example metadata 304 includes fields holding values for corresponding metadata parameters. In the illustrated embodiment, the metadata parameter fields include state update field 308, thread complete field 310, timestamp field 311, service identifier (ID) field 312, thread identifier (ID) field 313, document type field 314, thread type field 316, thread descriptors field 317, role descriptor field 318, related thread data field 320, state tags field 322 and state tables field 324.

Example business data 306 includes fields holding values for corresponding business parameters. In the illustrated embodiment the business parameter fields include rendering data field 326, user entered data field 328, field descriptions field 330, and forms/templates/actions fields 332.

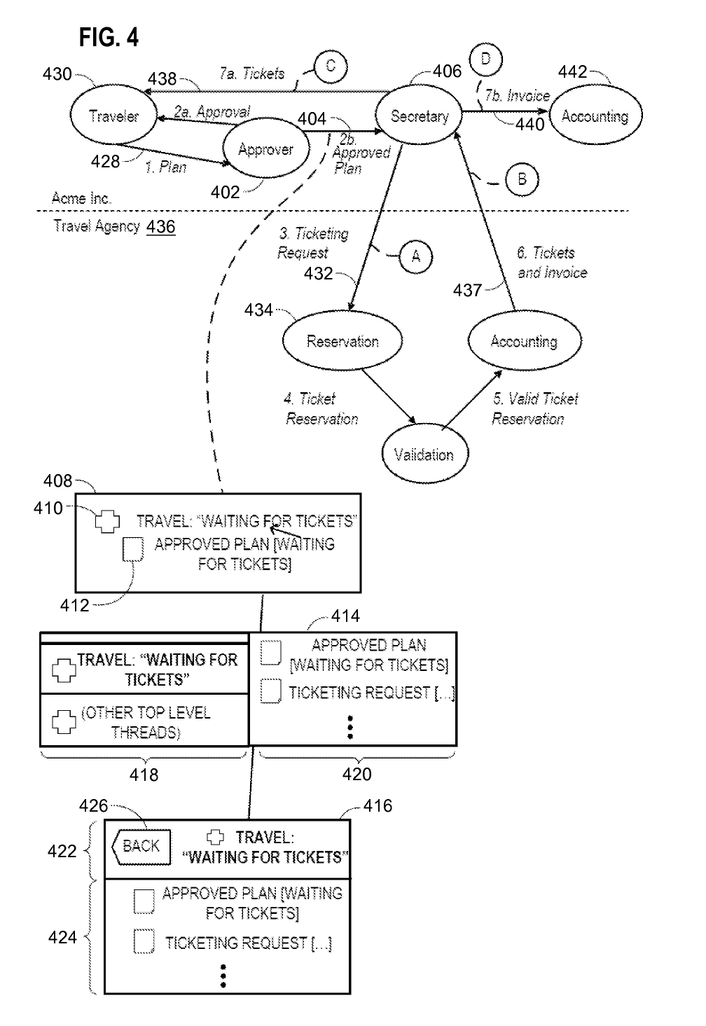

FIG. 4 is a diagram of a document flow for a document-flow based travel service in an organization, according to one embodiment. In FIG. 4, nodes for various roles (e.g., Approver node 402) are shown as vertices of a directed graph, with documents (e.g., Approved Plan 404) shown as edges of the graph. The graph in FIG. 4 relates to a particular example of document flow in support of travel planning and ticket reservation. In particular, the views of the document management system (e.g., view 408) are customized for the role of a secretary at secretary node 406 who processes a number of steps in the travel planning and ticket purchasing operations.

When the secretary node 406 has received the Approved Plan document 404, his/her user interface will show a threaded document flow, such as shown in block 408. The cross-shaped symbol 410 denotes a thread, and the paper symbol 412 denotes a document belonging to the thread. Note that while threads are shown here as a fully opened tree view, they could also be displayed one level at a time, similar to a file system. The latter may work better on a mobile device, where limited horizontal screen space makes indentation difficult. Examples of alternate views are shown in blocks 414, 416. In view 414, the selected level of the hierarchy (here the thread level) is shown in left pane 418, and items below the selected level are shown in right pane 420. In the view 416, each hierarchal level is displayed in a “flat” view, with a header portion 422 indicating the current “container,” and a list portion 424 showing all of the items within the container. The user navigates up the hierarchy by selecting control 426, and down the hierarchy by selecting an item from the list 424. Other views known in the art (e.g., directed graph, annotated list, etc.) may also be used as appropriate to the solution domain and target user interfaces.

The travel thread 410 is this instance is established for viewing the process relative to the secretary's role. Thus the travel thread 410 is created in this scenario when an Approved Plan document 404 is received by the secretary node 406. Although a travel thread could conceivably be created by some earlier event, e.g., when traveler node 430 submits the initial plan 428 to approver node 402, this thread is particular to the secretary node 406, which may not have any knowledge of that document 428. The Approved Plan document 404 contains a descriptor for the Travel thread, which may include the subject of the thread (“Travel” or “Travel for Traveler initiated on Date”), a unique thread ID, and possibly the ID of the thread's parent thread (in case of nested threads). Since this is the first document belonging to the thread that the client on node 406 has received, no corresponding thread is found on the client node 406, so a new thread is created and the document is attached to it.

The state of the new thread (shown in quotation marks in text associated with icon 410) is set from the StateUpdate field (e.g., field 308 in FIG. 3). The contents of the StateUpdate field are shown in brackets in the descriptive text accompanying icon 412. Note that the bracketed text and arrow shown in view 408 are for purposes of showing the relationship/updates between StateUpdate of the document 412 and state of the thread 410, and is not necessarily part of the user interface.

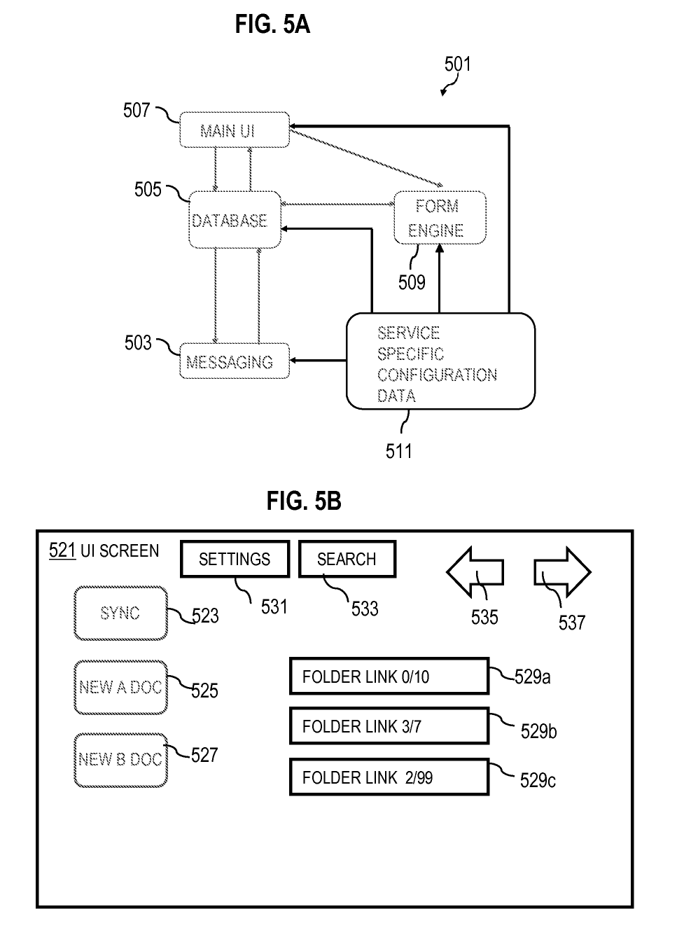

The secretary node 406 next opens the Approved Plan document 404. The form used to open the document allows the secretary node 406 to send a Ticketing Request document 432 to the reservations role 434 of travel agent 436. The form copies the Travel thread descriptor to the new document 432. In this example, this portion of the process (e.g., steps taken by agency 436) has been modeled as a sub-process when creating the service. Thus the form also attaches a new thread descriptor “Ticketing” to the document 432, marks the new thread descriptor as the immediate parent of document 532, and marks the old “Travel” thread descriptor as the parent of the new thread descriptor. The StateUpdate field (e.g., field 508 in FIG. 5) is set by the form to contain the text “Tickets Ordered.

A document 437 containing the tickets and the invoice arrives from the travel agency 436. The secretary node 406 next opens the Tickets and Invoice document 437. The form used to open the document may include a button for forwarding tickets 438 to the traveler 430. The secretary checks the information and then presses the “Forward to traveler” button. The form knows that the new Tickets document does not belong in the Ticketing thread, and removes the Ticketing thread descriptor from the Tickets document and makes the remaining Travel thread descriptor the immediate parent of the document.

The secretary node 406 later processes all invoices (e.g., at the end of the month). This is done by opening the Tickets and Invoice document 437 again, but pressing “Forward to accounting” button this time. The form requires the user of secretary node 406 to fill in budget-related information (cost codes, estimates etc.) and once complete, sends the Invoice document 440 to accounting 442. This time (based on use of different button) the form sets the StateUpdate field of the new document to “Invoice Sent.” The change of status causes a change in the status of the travel thread, and will also cause the thread to be marked as complete for the secretary node 406, based on a configured role-specific list of status values which signify thread completion, and/or or the thread complete field 310 in document metadata 304.

When creating a generic service platform such as described above, it is an advantage if the client software to implement the service is also generic, e.g., flexible enough to be used for several different document-flow based services. The configurability of the client determines to a large degree what kind of services can be run on the platform. However, it is difficult to create a truly flexible configuration mechanism that does not resort to scripting as the main configuration method. This is difficult to implement on a small capacity mobile device with intermittent connectivity. Thus, it is also an advantage for the client software to be configurable on a small capacity mobile device with intermittent connectivity.

According to the illustrated embodiments, a declarative configuration is used instead of scripts because a declarative configuration is easier to manage and generate than scripts, and has a smaller client-side footprint than a full-blown script engine. Also, it is difficult to implement a sufficiently efficient script engine in JAVA™, because to implement the various user interface (UI) configurations desired, a script needs to handle a large part of UI generation, which is a task that requires fast execution speed. Furthermore, certain required UI features, such as message layouts, can be quite complex.

One approach for implementing configurable UIs is a Web Runtime, which uses the Hypertext Markup Language (HTML), JavaScript and Cascading Style Sheets (CSS) to define the UI using standard web technologies. The advantage of such approach is that the technologies are well known by many developers and are quite powerful. The disadvantage is that implementing the technologies requires a large code and memory footprint and is not feasible to do in mobile Java.

According to the illustrated embodiments, declarative configuration is used in a client to control the storage, display, messaging or actions directed to one or more documents in a document-flow based service, alone or in some combination. FIG. 5A is a diagram of component modules for a small footprint, flexible client side module 501 for a document-flow based service, according to an embodiment. The architecture component modules include a messaging module 503, a database module 505, a main user interface (UI) module 507, a form engine 509 and service specific configuration data 511. Main UI module 507 presents folders for viewing lists of documents, buttons for creating new documents and a button for sending and receiving queued documents on one or more display screens. Messaging module 503 stores received documents in the database and sends any documents from the Outbox. Form Engine module 505 interprets form descriptions (such as XForms for XML documents), allowing the user to view and edit document metadata or business data or both (e.g., editing XML data in an XML document). Database module 505 stores documents to persistent storage as database transactions, extracts and saves document metadata whenever document data is changed, and maintains indexes (for quickly iterating through documents in a certain order) and counters (for keeping track of how many documents there are that match a certain filter).

Each of the modules 503, 505, 507 and 509 includes instructions for basic rules that are modified based on data retrieved from service specific configuration data 511. In an illustrated embodiment, the forms invoked by the form engine 509 are included in the service specific configuration data 511. In addition one or more folders for the Main UI module 507, and metadata parameters, indices, filters and counters for the database module 505 are included in the service specific configuration data 511. Similarly, the message service protocol and settings, and the contact addresses for the messaging module 503 are included in the service specific configuration data 511.

A small footprint client is provided for a different document-flow based service by including, in the service specific configuration data, different configuration data for the different service. Thus the small footprint client 501 is flexible enough to be used for multiple different services without substantially increasing the footprint on the client node; and thereby is well suited for even very basic mobile phones, as well as more capable nodes.

In an illustrated embodiment, the modules communicate with each other mainly through the database and database change events. For example, when the Messaging module 503 adds a new document to the database, the database module 505 issues a database event; and the Main UI module 507 notices the database change event and updates any currently open document list to show the new document if appropriate. Similarly, forms send documents by saving them to the database, setting addressing metadata (e.g. receiver email address) and setting their messaging status to “Outbox”. The Messaging module 503 reacts to the database change event, notices the new document with “Outbox” messaging status and attempts to send it. Once sending is complete, the Messaging module 503 changes the document's messaging status to “Sent”, which again causes to Main UI module 507 to update the current document list if appropriate. For example, if the user was viewing the “Outbox” folder, defined to be the documents with messaging status “Outbox”, the document will be removed from the document list.

FIG. 5B is a diagram of a screen 521 presented by the Main UI module, according to an embodiment. The screen 521 includes: a button 523 for synchronizing with the network (sending and receiving documents); buttons 525 and 527 for opening stand-alone forms (typically used to create new documents); a link 535 and link 537 to the previous and next screens, respectively; links 529a, 529b and 529c to corresponding folders that list individual threads and documents, and links to special screens such as link 531 to a Settings screen and link 533 to a Search screen. Each of the links 529a, 529b, 529c to the folders includes one or more document counts accumulated by counters associated with the folder, as described in more detail below.

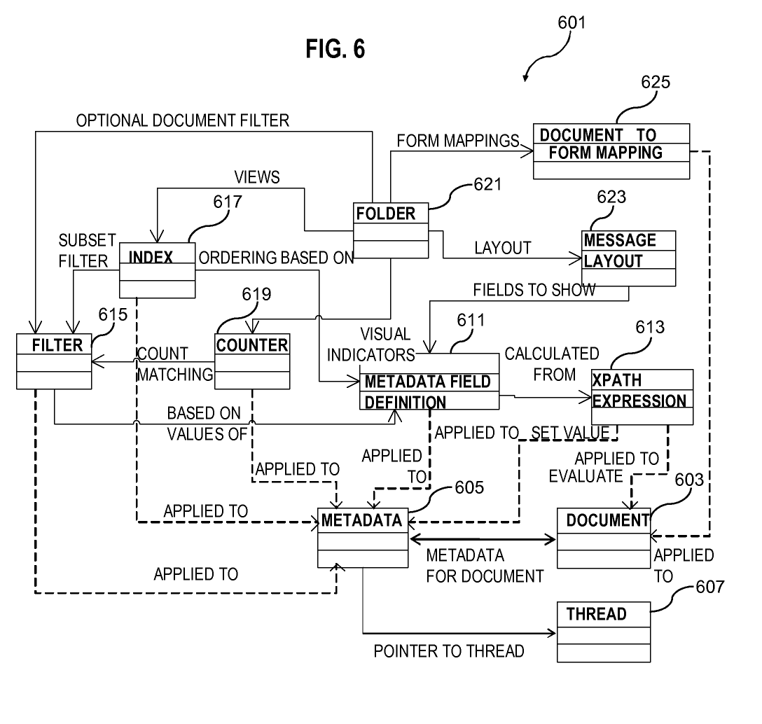

FIG. 6 is a diagram of relationships 601 among data objects for the client side module and a document for a document-flow based service, according to an embodiment. A data object, as is well known in the art, includes data structures for holding values of one or more parameters and methods for storing, retrieving or changing those values. The document data object 603 is stored in the database in association with metadata data object 605 for the document and, in some embodiments in association with a thread data object 607.

The client side modules, including the database module 505, determine what metadata parameters are used in the particular service based on a metadata field definition data object 611 derived from the service specific configuration data 511. This information is applied to organize the metadata data object 605. The locations of the metadata parameters in a particular document are determined by the path expressions in data object 613 (e.g., calculated using an XPath expression to locate a field in an XML document) obtained from the service specific configuration data 511. Some paths may depend on document type. These same expressions from the configuration data 511 are used to extract the metadata values from the document object 603 and store the metadata values into the metadata object 605 (and if applicable into thread data object 607).

The database module 505 maintains filter data objects 615 for one or more filters, each to exclude zero or more documents, or counter data objects 619 of number of documents that pass corresponding filters, and index data objects 617 for one or more index of sorted (and optionally filtered) documents based on the service specific configuration data 511. The filtering and sorting is based on the metadata values in the metadata data object 605 for one or more metadata parameters indicated by the metadata field definition data object 611 obtained from the configuration data 511.

The Main UI module 507 displays one or more folders of document lists based on folder data objects 621 defined by the configuration data 511 as views of an index. Some folders objects include counts from the counter data object 619. The configuration data 511 indicates which index and counter to use for a particular folder. The actual data to show for each listed document is indicated by the configuration data and stored in a message layout data object 623. The message layout data object 623 indicates for which metadata parameters to present values on each of one or more rows of an icon representing a document on a display screen.

When a user selects a document upon which to operate, the document is opened by the form engine module 509 using a form provided in the configuration data 511 and associated with a document type in a document to form mapping object 625 also included in the configuration data 511.

In some embodiments, each document in the database includes a metadata parameter indicating a priority and a processing status managed by the client side module. In some embodiments, a message status is also associated with a document by the client side module. Priority is one of (in increasing priority order): 1. “For your information” (FYI); 2. “Action required”; and 3. “Urgent action required.” Processing status is one of (in order of increasing level of processing by user): 1. “Unread”; 2. “Read”; and 3. “Processed”. Documents other than FYI messages require the user to take some action, e.g. submit a reply or forward an edited document. Once the action has been taken, the message enters “Processed” status. FYI priority messages never enter “Processed” status, since there is nothing to process.

In some embodiments, the display of a document listing, called the document icon hereinafter, is based, at least in part, on the priority/status combination. For example, the document icon is formatted according to Table 1.

TABLE 1
Document icon format based on priority (row) and processing status
(column) combination.

| | Unread | Read | Processed |
|---|---|---|---|
| FYI | Bold text, “FYI” | Normal text, “FYI | — |
| | icon | icon” | |
| Action | Bold text, empty | Normal text, empty | Normal text, |
| Required | checkbox icon | checkbox icon | checked checkbox |
| | | | icon |
| Urgent | Bold text, empty | Normal text, empty | Normal text, |
| Action | checkbox with | checkbox with | checked checkbox |
| Required | exclamation mark | exclamation mark | icon |
| | icon | icon | |

In addition, coloring and other such visual effects are used in some embodiments to indicate processing status. For example, in some embodiments, green color is used with “Processed” status documents to indicate that no further action is required for them.

In some embodiments, the document icon associated with a priority/status combination is in the basic display rules of the client side module. In some embodiments, the configuration data 511 includes different document icon options for priority/status combinations that override default icon formats in the basic display rules.

When document threads are employed, the thread uses similar visual indication as an overlay icon on top of the thread icon. For example, in some embodiments, the overlay icon is presented as unread if the thread contains at least one unread message; is presented as normal unprocessed if thread contains at least one normal unprocessed (e.g., processed status is other than processed) message but no urgent unprocessed messages, and is presented as urgent unprocessed if thread contains at least one urgent unprocessed message.

Although a particular set of modules, data structures and data objects are shown in FIG. 5 and FIG. 6 for purposes of illustration, in various other embodiments more or fewer modules and data structures and data objects are involved. Furthermore, although modules, data structures and data objects are depicted as particular blocks in a particular arrangement for purposes of illustration, in other embodiments each module, data structure or data object, or portions thereof, may be separated or combined or arranged in some other fashion.

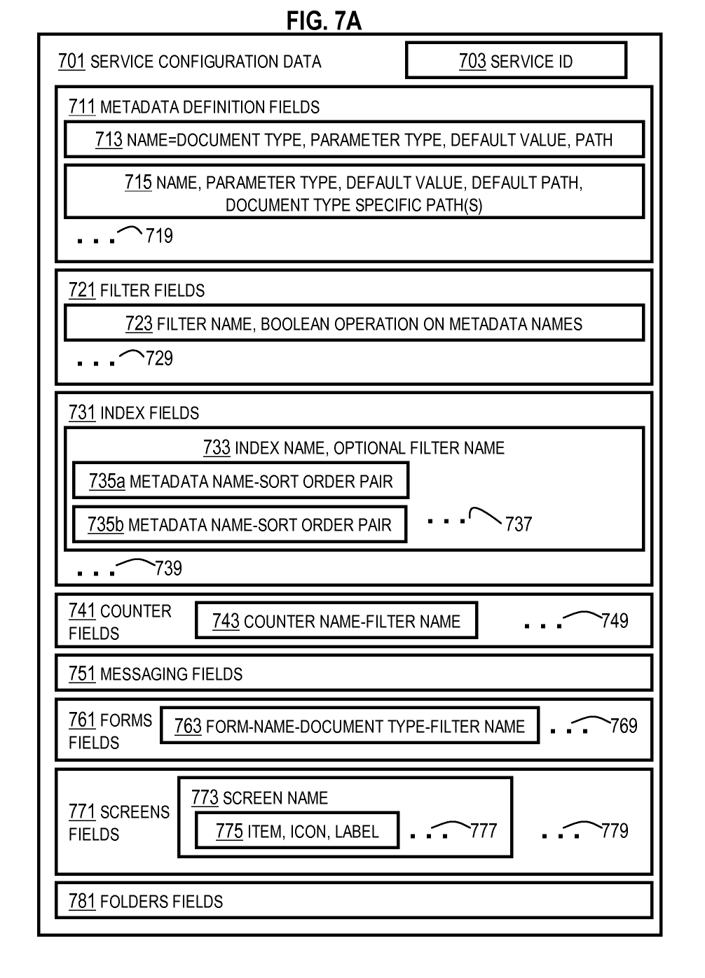

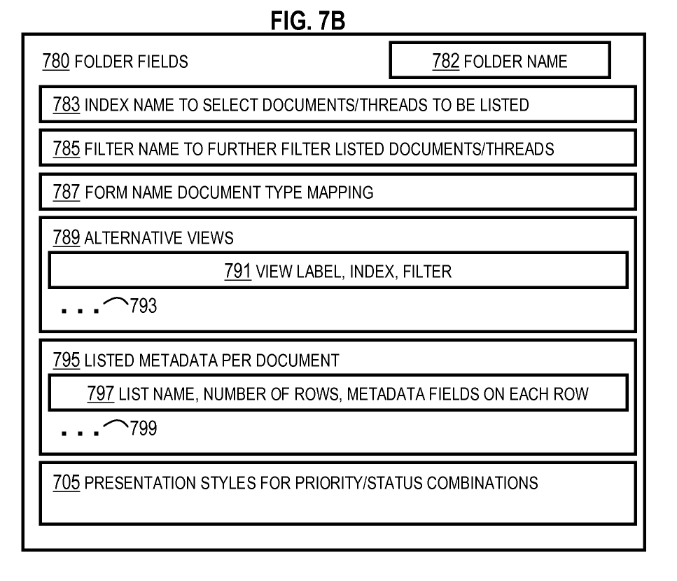

FIG. 7A is a diagram of the configuration data 701 for a particular service, according to an embodiment. In some embodiments, the configuration data 701 is provided in a configuration document. For example, in an illustrated embodiment, the service specific configuration data 701 is received at the client side module in an XML document attached to an email message addressed to a user of the node where the client side module resides. In some embodiments, the email message indicates a directory on the node's file system where the attached XML document is to be saved, e.g., as service specific configuration data structure 511.

Typically, an XML document indicates a parameter name and parameter value for all data included in the document, and allows one parameter to be nested in another. The type, number and allowed nesting of parameters for an XML document of a particular type are specified in an XML dictionary file shared among all nodes that will use XML documents of that type. The XML document begins with a field specifying the XML document type and associated XML dictionary.

The service configuration data 701 includes a service identifier (ID) field 703, metadata definition fields 711, filter fields 721, index fields 731, counter fields 741, messaging fields 751, forms fields 761, screens fields 771, and folders fields 781.

The service ID field 703 holds data that indicates the particular document-flow based service configured with the remaining configuration data, such as indicated in service ID field 312 depicted in FIG. 3. For example, field 703 holds data that indicates a purchase order service or a travel service as described above.

Metadata definition fields 711 includes a field for each metadata parameter, including field 713, field 715 and additional fields indicated by ellipsis 719, for automatically extracting metadata values from a document. Because some metadata definition information depends on document type, an especially useful metadata definition field is field 713. Field 713 includes data that indicates a name of the metadata parameter is “document type”, data that indicates the parameter type (e.g., whether number or character or text string of characters or some other codec, or maximum and minimum values, etc.), data that indicates a default value, and data that indicates a path to the document type in the received document. To simplify the path specification, in some embodiments all documents for a particular service (as indicated by a particular value for the service ID field 703) locate the document type field so as to be specified by the same path expression, e.g., at the same position within the document. In an illustrated embodiment, the documents for the particular service are XML documents and the path data is an XPath expression, well known in the art.

Metadata definition field 715, for other metadata parameters than document type, includes data that indicates a name of the metadata parameter, data that indicates the parameter type, data that indicates a default value, and data that indicates a path to the document type in the received document. In some embodiments, the path to the metadata parameter depends on the document type and the path is indicted by one or more document type specific paths that each comprise a document type and path expression pair. In some of these embodiments, the metadata definition field 715 includes data that indicates a default path to use in documents that are of a different type from any listed in those pairs. Ellipsis 719 indicates zero or more additional metadata definition fields like field 715.

Filter fields 721 includes a field for each filter used by the particular service, including field 723 and additional fields indicated by ellipsis 729, for automatically filtering a document based on metadata values for that document. As used herein, a filter is a function that receives as input data that indicates a document, such as a document identifier (ID) or the document content itself, and outputs a value indicating “TRUE” if the document passes, and outputs a value of “FALSE” if the document does not pass. In an illustrated embodiment, a field for each filter, e.g. field 723, holds data that indicates a filter name and data that indicates a Boolean expression that operates on metadata values indicated by metadata parameter names. Documents for which metadata values cause the expression to return a value of TRUE are said to “match the filter.”

Index fields 731 includes a field for each index used by the particular service, including field 733 and additional fields indicated by ellipsis 739, for automatically sorting documents in a desired order. Each index field 733 include data that indicates an index name and an optional filter name referring to one of the filters described in field 721 so that only matching documents are sorted. In some embodiments, multiple filters are named. Each index field also includes one or more sort order fields, e.g. field 735a, field 735b and additional sort order fields indicated by ellipsis 737, collectively referenced hereinafter as sort order fields 735. Each sort order field 737 includes data that indicates a metadata parameter name and sort order pair for a successively deeper level of sorting. The metadata name indicates the metadata parameter for which the values are used to sort multiple documents. The sort order indicates how the values are sorted (e.g., increasing numeric order, decreasing numeric order, increasing alphabetical order, increasing date order, etc.). In some embodiments, the system can automatically determine correct ordering type (e.g., numeric, date) based on the type of the value in the metadata field; and sort order need not specify more than just increasing or decreasing. Documents with the same value for the first metadata parameter are listed in a specified order according to the second metadata parameter. An index may also have an optional filter for limiting the documents that are indexed. For example, an index might be defined that only contains documents of type “order.clothing” rather than all documents of type “order”. Smaller indexes are faster and take up less space, so filtering before sorting is very useful.

Counter fields 741 includes a field for each counter used by the particular service, including field 743 and additional fields indicated by ellipsis 749, for automatically keeping count of number of documents that match a particular set of one or more filters. Recall that filters are defined by the configuration data in fields 721, described above. Counters are efficient because they are kept current by automatically updating whenever the database is updated (a minimal overhead), instead of recalculating the value whenever it is queried. Not all filters are associated with counters, just those considered especially useful to the service, e.g., the number of unprocessed urgent documents. In an illustrated embodiment, a field for each counter, e.g. field 743, holds data that indicates a counter name and data that indicates a filter name for one of the filters defined in the filter fields 721.

In some embodiments, the basic database rules includes one or more filters or counters or indexes in addition to any defined in the configuration data 701.

Messaging fields 751 includes data that indicates the interactions with the messaging service used to send documents between nodes. Most mobile devices have one or more messaging services, such as electronic mail, instant messaging, text messaging using short messaging service protocol (SMS) and multimedia messaging using multimedia messaging service protocol (MMS). It is often more efficient to exploit one of these messaging services than to develop an independent messaging service for sending and receiving documents of the document-flow based service. For example, if email is used for sending and receiving documents, then Simple Mail Transfer Protocol (SMTP) or Internet Message Access Protocol (IMAP) information (including username and password) is indicated by data in messaging fields 751. In some embodiments, sending and receiving email may be done either manually or automatically with a configurable interval between connection; and this information is also indicated by data included in the messaging fields 751.

Forms fields 761 includes a field for each form used by the particular service, including field 763 and additional fields indicated by ellipsis 769, for allowing a user to view, modify and direct a document. In an illustrated embodiment, a field for each form, e.g. field 763, holds data that indicates a form name, data that defines the form and data that indicates a filter name and document type on which the form may act. In some embodiments, data indicating the document type or filter name or both are omitted. In some embodiments, forms are XML documents that specify a form according to the XForms standard. Typically each form is associated with a Uniform Resource Identifier (URI) that is used to refer to the form stored elsewhere on the device or network; and just the URI is included in the field 763. Note that forms are able to read and write documents and metadata from the database. Forms can also search for documents by giving a filter specification and perform other functions invoked by buttons or other active graphical elements, well known in the art. The search returns a list of matching documents which can then be retrieved in the form one by one. In some embodiments, forms indicated in a user interface or folder mapping, described below, are referenced completely by their URI, and separate forms fields 761 are omitted.

Screens fields 771 includes a field for each screen used by the Main UI for a particular service, including field 773 and additional fields indicated by ellipsis 779, for automatically displaying document icons, actions or roles associated with a service. Each screen field 773 includes data that indicates a screen name. Each screen field 773 also includes one or more icon fields, e.g. field 775 and additional icon fields indicated by ellipsis 777, collectively referenced hereinafter as icon fields 775. Each icon field 775 holds data that indicates an item to be presented on the screen, an icon for the item and a label for the item.

The main UI module generates a UI that consists of a tree-like structure of screens and folders. Each screen may contain one or more of the following, as depicted in FIG. 5B: a button 523 for synchronizing with the network (sending and receiving documents); one or more buttons 525, 527 for opening stand-alone forms (typically used to create new documents); one or more links 535, 537 to other screens; one or more links 529 to folders; and one or more links 531, 533 to special screens, such as a Settings screen or a Search screen. The screens and their contents are defined in the configuration screens fields 771. For example, in each screen field 773 is an icon field 775 for all the items the screen contains. In each icon field 775 is data indicating the item, an icon and a label associated with the item.

In some embodiments, a form reference contains parameters for invoking the form. The parameters may include resource documents such as a product catalog, or simple (string) values. For example, the same purchase request form may be used to request purchases from multiple stores by varying the product catalog resource parameter. For another example, a single form may be able to operate in brief mode (showing only the most important information) or in verbose mode (showing all information), depending on the value of a simple string parameter (“brief” or “verbose”). In this way, forms can be reused for slightly different purposes by varying the parameters. The form reference is typically an URI which is part of the form metadata, so form content can easily be found from the database given the URI.

For link items, the identifier of the linked screen or folder is additionally given. For stand-alone form items, an identifier of the form, such as a URI, is given. For folder link items, several counters are indicated, since folder links show information about the documents the folder contains. For example, the folder items hold data that indicates counters, either directly or indirectly by naming a folder in the folder fields 781 described next. For example, a folder link item 529 indicates: the number (or existence) of documents in the folder; the number (or existence) of unread documents; the number (or existence) of unprocessed documents; or the number (or existence) of urgent unprocessed documents.

The counters for a folder link may be visualized in various ways. For example, one or two counters can be shown next to the folder label, e.g., “Inbox (2/34)”. Typically this means that there are 2 new documents and 34 documents in total. However, since the numbers come from arbitrary counters in various configuration documents, they can actually be anything configured, e.g. they could mean that there are 2 urgent documents and 34 unprocessed documents. Instead of showing the actual count, it is also possible to use overlay icons, text style or coloring to show whether the count is non-zero. For instance, if the count of unprocessed documents is non-zero, the link to the folder could show an empty checkbox overlay icon. This can be configured by specifying the effect (overlay icon and its relative location on the folder icon, text style, text color) and the counter to use.

For special screens, the desired configuration varies. For the Settings screen, little or no configuration is desired because the Setting screen is typically used mainly to change configuration for the Messaging module 503. For the search screen, various search templates (filled in by a user when searching) are typically defined based on configuration data.

FIG. 7B is a diagram of folder fields 780 for one folder, according to an embodiment. Multiple folder fields depicted in FIG. 7B may be included in the folders field 781 of FIG. 7A. In the illustrated embodiment, the folder fields 780 include a folder name field 782, an index name field 783, a filter name field 785, a form mapping field 787, alternative views field 789, listed metadata per document field 795, and presentations styles field 705.

A folder provides a view to the document database, listing the documents and document threads that are visible in the view, such as views 408, 414 and 416 depicted in FIG. 4. For each document or thread, a configurable set of metadata is displayed in the list. The user can navigate in the list, view additional metadata on the currently selected document or thread, and open the currently selected document or thread. If a document is opened, a form is selected according to configured document-to-form mapping, the form is opened and the document is given to the form as a parameter. These forms include a document parameter, in contrast to the previously mentioned stand-alone forms which do not. If a thread is opened, the documents and threads that belong to the thread are shown in a list.

The folder name field 782 holds data that indicates a name for the folder, so that it can be incorporated by name in one or more screens.

The index name field 783 holds data, such as an index name, that indicates an index to be used to select and sort the documents or threads to be listed in the folder. The filter name field 785 holds data, such as a filter name, that indicates a filter to be used to filter the documents or threads to be included in the folder, in addition to any filter already associated with the index named in field 783. This field is optional and is used to select a subset of documents in the index, so that only the subset is shown. Note that if the same filter is always used with a certain index, it is more efficient to specify an index that includes the filter in the index definition.

The form mapping field 787 holds data that indicates a mapping between document types or names and form names. The data in field 787 defines which form should be used to open a document. Typically the form selection depends at least on document type, but may also depend on other document or process metadata, e.g. the user's role with regard to the document. For example, a different form could be used when the user opens a travel claim in Traveler role than when a travel claim is opened in Approver role. Typically a form mapping consists of a list of rules expressed as “condition→form”. The rules are evaluated in order and the first time the condition evaluates to “TRUE”, the form specified by that rule is selected. An example condition is “document type=order.clothing and role=Supplier”. Note that type matching takes subtypes into account, so condition “document type=order” would also match documents of type “order.clothing”.

Alternative views fields 789 includes a field for each alternative view selected or used by a user of the particular service, including field 791 and additional fields indicated by ellipsis 793. In an illustrated embodiment, a field for each alternative view, e.g. field 791, holds data that indicates a view label and data that indicates an index name and a filter name for one of the index or filters defined above. One alternative view is selected by a user for the same folder, such as when a particular document listing or icon is in focus, e.g., highlighted by the user. These are typically shown (using the specified label) in the Options menu as sub-items for a “View” menu item on a Screen. When the user selects an alternative view, the current index and optional filter are replaced with the ones defined for the alternative view (if given). For example, an alternative view can be defined with the label, index and filter of “Only Orders”, null, document type=“order”, respectively. If the user selects Options→View→Only Orders, the current index is unaffected but the current optional filter is replaced with document type=“order.”

Listed metadata fields 795 includes a field for each alternative set of metadata to display with a document icon, including field 797 and additional fields indicated by ellipsis 799. In an illustrated embodiment, a field for each listed metadata option, e.g. field 797, holds data that indicates a listing option name, a number of rows and metadata parameters to include in order on each row. For example, a certain number of rows (typically 1 or 2) has been allocated for each document in the list, and the configuration defines for each row which metadata fields to display, and how much of the row should be allocated for each metadata field. Note that there may be alternative layouts provided, e.g. if the user is able to select between options for 1 row per item and 2 rows per item. In some embodiments, a listed metadata field 797 is included for the currently focused item and the layout for showing it. This is useful when the currently focused item is automatically expanded to show more detail. In some embodiments a listed metadata field 797 is included for additional set of metadata (and a label for each field) to show for the currently focused item when the user selects “Options→Properties” or similar context-sensitive command.

The presentation styles field 705 holds data that indicates one or more presentation styles to be used for priority/processing status combinations to overrule the default styles, e.g., listed in Table 1.

Although a particular set of fields are depicted in FIG. 7A and FIG. 7B as particular blocks in a particular order within a single document for purposes of illustration, in other embodiments each field, or portion thereof, may be separated or combined or arranged in two or more documents or data structures or data objects or databases on one or more nodes of a network.

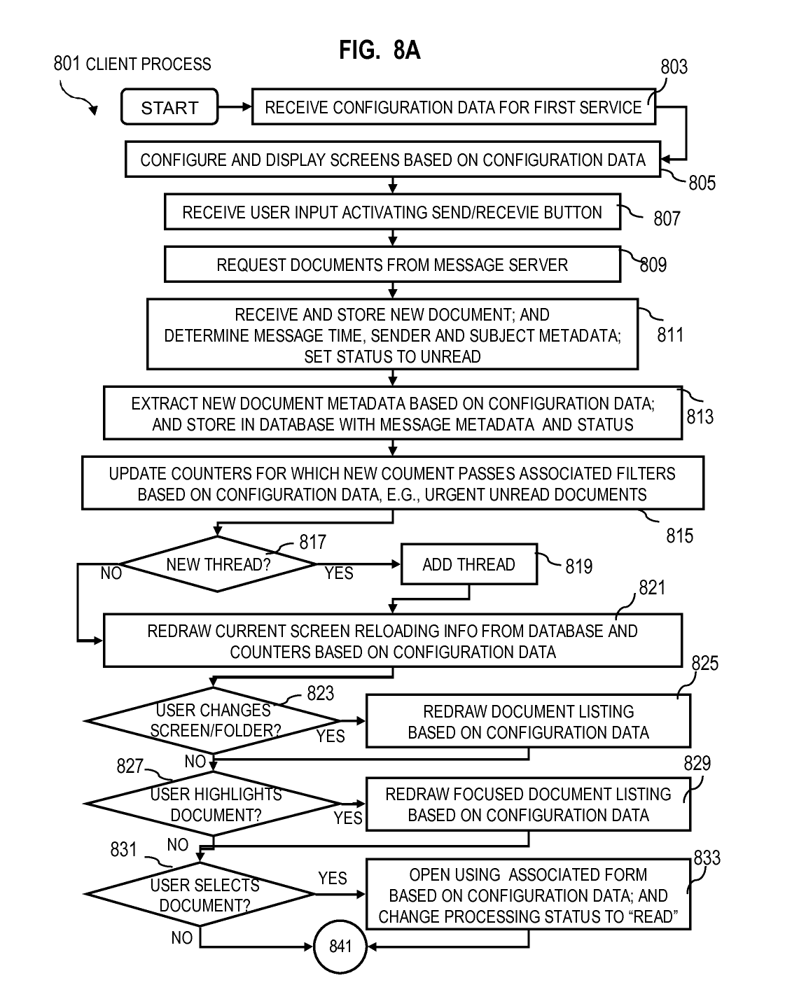

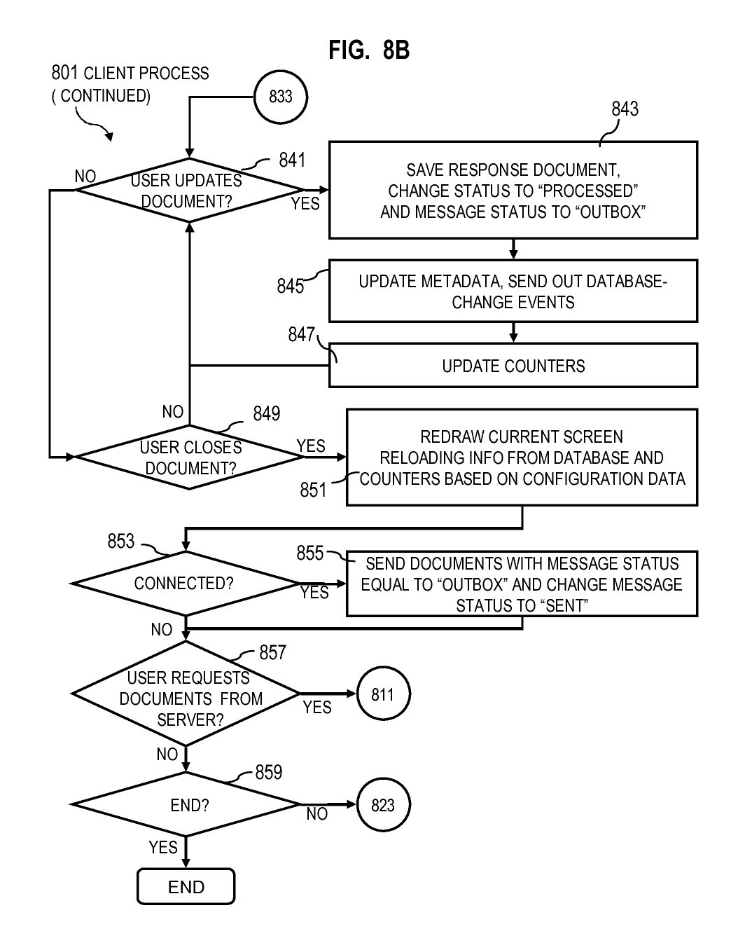

FIG. 8A and FIG. 8B are flowcharts of a client side process 801 to handle a document for a document-flow based service, according to one embodiment. Although steps in FIG. 8A and FIG. 8B are show in a particular order for purposes of illustration, in other embodiments, one or more steps may be performed in a different order or overlapping in time, in series or in parallel, or one or more steps may be omitted or added, or changed in some combination of ways.

In 803, configuration data, such as values for the fields depicted in FIG. 7A, are received for a first service. A different service can be implemented at a later time using the same process and modules, but with different configuration data values for the same configuration fields.

Any method may be used to receive the configuration data in step 803. For example, in various embodiments, the data is included as a default value in software instructions, is received as manual input from a network administrator on the local or a remote node, is retrieved from a local file or database, or is sent from a different node on the network, either in response to a query or unsolicited, or the data is received using some combination of these methods. In an example embodiment, a user owns a limited capacity mobile device with the database, messaging, Main UI and form engine modules depicted in FIG. 5. The user then decides to install a travel service client on that mobile device, e.g., after being prompted by a message from a different user or an advertisement in a web page displayed by a reduced browser on the user's mobile device. The user requests an installation of the service and is asked to provide the user's email address. An XML configuration document is included as an attachment in an email message sent to the user's email address and received on the user's mobile device. In some embodiments, the attached XML document is placed in a default directory in the user's file system that is known by the client process. In some embodiments, the user is asked to store the attached XML configuration document in a different directory specified by the email message.

In step 805 the client side module is configured based on the configuration data; and a configured display screen of the Main UI module, e.g., screen 521, is presented to the user.

In step 807, user input is received activating a send/receive button, such as sync button 523. This indicates the user wishes to send any documents marked “Outbox” to the designated destination and to receive any new, unread documents from one or more other nodes in the network. A request for documents is sent to a message server in step 809. For example, the Messaging module 503 connects to an email server and downloads a new email message, which contains a new document.

In step 811 the new document is received and stored and message metadata is determined. Message metadata describes the message in which the document is received, and includes information such as a time of delivery, an identifier for a sender or text in a subject line. In some embodiments, the message metadata extraction is a fixed part of the client—not based on the configuration data. For example, the Messaging module 503 saves the document to the Database module 505 and sets the MessageReceiveTime, MessageSender and MessageSubject metadata fields for it, taken from the email headers. The document may also contain similar information but the document contents are processed by metadata extraction phase in the Database module 505.

In step 813 metadata for the new document is extracted based on the configuration data, and stored in the database module 505 with the message metadata and processing status. A metadata extraction rule is modified based on configuration data 511; and metadata is extracted from the document received in the message using the modified extraction rule. For example, the Database module 505 extracts metadata from the document according to the configured set of metadata fields (by evaluating the associated XPath expressions) and saves both document and metadata.

In step 815, affected indexes and counters are also updated. For purposes of illustration, it is assumed that the document metadata includes a parameter named “Priority” with a value “Urgent” so the counter which counts urgent unprocessed documents is incremented by 1. Any listeners for database change events are notified.

In step 817, it is determined whether a new thread is indicated in the document metadata extracted. If so, then a new thread is added to the appropriate folder in step 819. In either case, in step 821, the current screen is redrawn, reloading information from the database in response to the database event and the updated counters. For example, the Main UI module 507 receives the database change event. If the new document begins a new thread, the thread is created. The current screen is redrawn, which reloads information from the database and thus ensures on-screen information is up-to-date. Assuming that the user was viewing a folder named “Inbox” which shows all received documents, the document list is redrawn and the new document is displayed using the configured set of metadata (e.g. DocumentSubject, DocumentSender, MessageReceiveTime) associated with a document icon. If, on the other hand, the user was viewing a screen with a link to the folder “Inbox,” the change in the urgent unread document counter is shown e.g. by displaying a small overlay icon with a checkbox and an exclamation mark on top of the folder icon. Thus a display rule is modified based on the configuration data; and the metadata is displayed using the modified display rule.

In step 823, it is determined whether the user has indicated a change to the screen or folder displayed, e.g., by selecting a link to another screen or folder. If so, the document listing is redrawn in step 825 for the new screen/folder based on the configuration data for listing documents.

In step 827 it is determined if the user has highlighted a document, e.g., by pausing or clicking a pointing device positioned when a cursor is positioned over the document listing. If so, then in step 829, the document listing is redrawn based on the configuration data for an alternate view. For example, the user navigates to the new document. An extended set of metadata is shown for the document (based on the configuration data) since it is now focused and the UI element expands to show values for more metadata parameters.

In step 831, it is determined whether the user has selected a document to open. If so, then in step 833 the document is opened in an associated form based on the configuration data. Also in step 833, the processing status for the document, if currently “Unread” is changed to “Read.” For example, when the user clicks to open the document, the Main UI module 507 looks in the folder's form mapping to find a mapping that matches the current document. When the mapping is found, the form specified by the mapping is opened and the document is given to it as a parameter. Just prior to opening the form, the Main UI module 507 changes the document processing status to Read, if it was Unread before. Thus the client opens the document in a form selected from a plurality of forms included in the configuration data. The form presents the document to a user of the apparatus and controls what can be changed in the document by the user.

The next steps are depicted in FIG. 8B. In step 841, it is determined whether the user updates the current document using one of the fields in the associated form. If so, then in step 843 the revised document, called the response document, is saved as a new document in the database. Depending on the form, the processing status is changed to “Processed” if not already set to Processed, as shown in the illustrated embodiment. Also, a message status is set to “Outbox.” In step 845 the metadata in the database is updated to reflect the updated metadata in the document and a database change event is issued. Thus the modified document is stored and the database of the metadata is updated based on the modified document. In step 847, affected counters listening to the database events update their count accordingly. Control passes back to step 841 to determine if the user makes more changes.

If the user does not update the document further, then in step 849 it is determined if the user closes the form. If not, then control passes back to step 841. If so, then in step 851 the current screen is redrawn reloading information from the database and counters. Both the display and the counters are based on the configuration data. For example, the Main UI module 507 receives the database change event and updates its message list to show that the document status is now “Processed”. Once the changes to the database are done, the form displays a success message and the user can close the form, returning the user to the Main UI message list (e.g., Inbox Screen or folder).

In step 853, it is determined if the node hosting the client is connected to the network. If so, then in step 855 documents with a message status of “Outbox” are sent to the specified destinations and the message status for the document is changed to “Sent.” If not, then the document is saved until a connection is available, in a store and forward process well known for mobile devices with intermittent connectivity. For example, the Messaging module 503 receives the database changed event and sends the response document via email. Once done, the Messaging component changes the messaging status of the response document to “Sent.” In some embodiments, the response document may remain in “Outbox” messaging status until the user manually synchronizes with the network, e.g., in step 807.

In step 857, it is determined if the user requests documents from a server. If so, then control returns to step 811 to receive and store the new document, described above. If not, then in step 859 it is determined whether the client is to stop. If so, then the client process ends. Otherwise control passes back to step 823 to detect a change in screen or folder indicated by the user, as described above.

The illustrated embodiment provides an ultra-configurable client for XML document flow services. It can be implemented with smaller footprint and the configuration is easier to generate and maintain than script-based solutions. The configuration allows for great flexibility in the applications that can be supported with the same basic rules and architecture. In an illustrated embodiment, the configuration is entirely in XML. Therefore existing advanced XML infrastructure (e.g. XSLT and other XML template mechanisms) can be used for generating configuration files.

The processes described herein may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such example hardware for performing the described functions is detailed below.

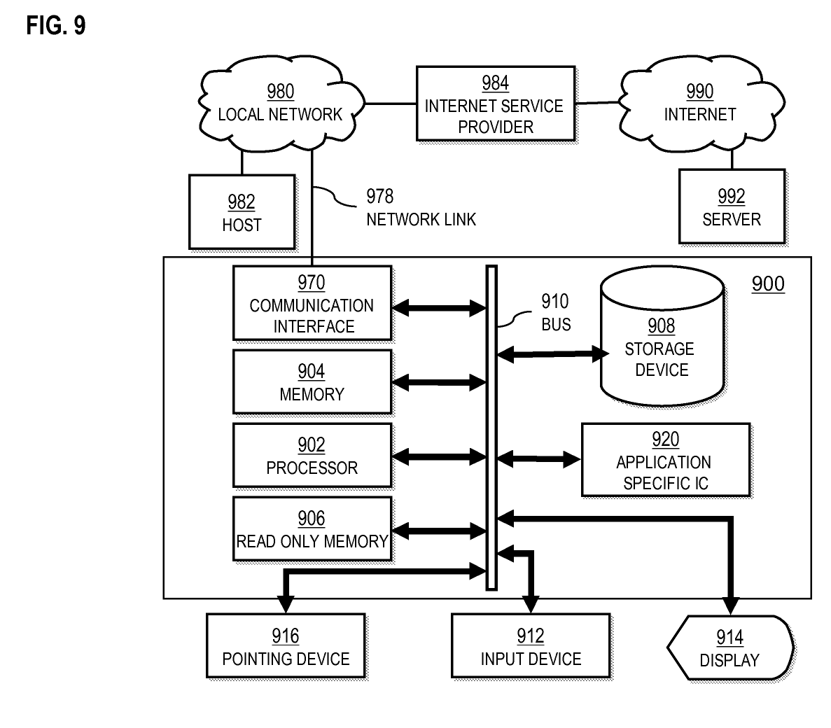

FIG. 9 illustrates a computer system 900 upon which an embodiment of the invention may be implemented. Computer system 900 includes a communication mechanism such as a bus 910 for passing information between other internal and external components of the computer system 900. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range.

A bus 910 includes one or more parallel conductors of information so that information is transferred quickly among devices coupled to the bus 910. One or more processors 902 for processing information are coupled with the bus 910.

A processor 902 performs a set of operations on information. The set of operations include bringing information in from the bus 910 and placing information on the bus 910. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 900 also includes a memory 904 coupled to bus 910. The memory 904, such as a random access memory (RAM) or other dynamic storage device, stores information including processor instructions. Dynamic memory allows information stored therein to be changed by the computer system 900. RAM allows a unit of information stored at a location called a memory address to be stored and retrieved independently of information at neighboring addresses. The memory 904 is also used by the processor 902 to store temporary values during execution of processor instructions. The computer system 900 also includes a read only memory (ROM) 906 or other static storage device coupled to the bus 910 for storing static information, including instructions, that is not changed by the computer system 900. Some memory is composed of volatile storage that loses the information stored thereon when power is lost. Also coupled to bus 910 is a non-volatile (persistent) storage device 908, such as a magnetic disk, optical disk or flash card, for storing information, including instructions, that persists even when the computer system 900 is turned off or otherwise loses power.

Information, including instructions, is provided to the bus 910 for use by the processor from an external input device 912, such as a keyboard containing alphanumeric keys operated by a human user, or a sensor. A sensor detects conditions in its vicinity and transforms those detections into physical expression compatible with the measurable phenomenon used to represent information in computer system 900. Other external devices coupled to bus 910, used primarily for interacting with humans, include a display device 914, such as a cathode ray tube (CRT) or a liquid crystal display (LCD), or plasma screen or printer for presenting text or images, and a pointing device 916, such as a mouse or a trackball or cursor direction keys, or motion sensor, for controlling a position of a small cursor image presented on the display 914 and issuing commands associated with graphical elements presented on the display 914. In some embodiments, for example, in embodiments in which the computer system 900 performs all functions automatically without human input, one or more of external input device 912, display device 914 and pointing device 916 is omitted.

In the illustrated embodiment, special purpose hardware, such as an application specific integrated circuit (ASIC) 920, is coupled to bus 910. The special purpose hardware is configured to perform operations not performed by processor 902 quickly enough for special purposes. Examples of application specific ICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 900 also includes one or more instances of a communications interface 970 coupled to bus 910. Communication interface 970 provides a one-way or two-way communication coupling to a variety of external devices that operate with their own processors, such as printers, scanners and external disks. In general the coupling is with a network link 978 that is connected to a local network 980 to which a variety of external devices with their own processors are connected. For example, communication interface 970 may be a parallel port or a serial port or a universal serial bus (USB) port on a personal computer. In some embodiments, communications interface 970 is an integrated services digital network (ISDN) card or a digital subscriber line (DSL) card or a telephone modem that provides an information communication connection to a corresponding type of telephone line. In some embodiments, a communication interface 970 is a cable modem that converts signals on bus 910 into signals for a communication connection over a coaxial cable or into optical signals for a communication connection over a fiber optic cable. As another example, communications interface 970 may be a local area network (LAN) card to provide a data communication connection to a compatible LAN, such as Ethernet. Wireless links may also be implemented. For wireless links, the communications interface 970 sends or receives or both sends and receives electrical, acoustic or electromagnetic signals, including infrared and optical signals, that carry information streams, such as digital data. For example, in wireless handheld devices, such as mobile telephones like cell phones, the communications interface 970 includes a radio band electromagnetic transmitter and receiver called a radio transceiver.

The term computer-readable medium is used herein to refer to any medium that participates in providing information to processor 902, including instructions for execution. Such a medium may take many forms, including, but not limited to, non-volatile media, volatile media and transmission media. Non-volatile media include, for example, optical or magnetic disks, such as storage device 908. Volatile media include, for example, dynamic memory 904. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media.

Common forms of computer-readable media include, for example, a floppy disk, a flexible disk, a hard disk, a magnetic tape, or any other magnetic medium, a compact disk ROM (CD-ROM), a digital video disk (DVD) or any other optical medium, punch cards, paper tape, or any other physical medium with patterns of holes, a RAM, a programmable ROM (PROM), an erasable PROM (EPROM), a FLASH-EPROM, or any other memory chip or cartridge, a transmission medium such as a cable or carrier wave, or any other medium from which a computer can read. Information read by a computer from computer-readable media are variations in physical expression of a measurable phenomenon on the computer readable medium. Computer-readable storage medium is a subset of computer-readable medium which excludes transmission media that carry transient man-made signals.

Logic encoded in one or more tangible media includes one or both of processor instructions on a computer-readable storage media and special purpose hardware, such as ASIC 920.

Network link 978 typically provides information communication using transmission media through one or more networks to other devices that use or process the information. For example, network link 978 may provide a connection through local network 980 to a host computer 982 or to equipment 984 operated by an Internet Service Provider (ISP). ISP equipment 984 in turn provides data communication services through the public, world-wide packet-switching communication network of networks now commonly referred to as the Internet 990. A computer called a server host 992 connected to the Internet hosts a process that provides a service in response to information received over the Internet. For example, server host 992 hosts a process that provides information representing video data for presentation at display 914.

At least some embodiments of the invention are related to the use of computer system 900 for implementing some or all of the techniques described herein. According to one embodiment of the invention, those techniques are performed by computer system 900 in response to processor 902 executing one or more sequences of one or more processor instructions contained in memory 904. Such instructions, also called computer instructions, software and program code, may be read into memory 904 from another computer-readable medium such as storage device 908 or network link 978. Execution of the sequences of instructions contained in memory 904 causes processor 902 to perform one or more of the method steps described herein. In alternative embodiments, hardware, such as ASIC 920, may be used in place of or in combination with software to implement the invention. Thus, embodiments of the invention are not limited to any specific combination of hardware and software, unless otherwise explicitly stated herein.

The signals transmitted over network link 978 and other networks through communications interface 970, carry information to and from computer system 900. Computer system 900 can send and receive information, including program code, through the networks 980, 990 among others, through network link 978 and communications interface 970. In an example using the Internet 990, a server host 992 transmits program code for a particular application, requested by a message sent from computer 900, through Internet 990, ISP equipment 984, local network 980 and communications interface 970. The received code may be executed by processor 902 as it is received, or may be stored in memory 904 or in storage device 908 or other non-volatile storage for later execution, or both. In this manner, computer system 900 may obtain application program code in the form of signals on a carrier wave.

Various forms of computer readable media may be involved in carrying one or more sequence of instructions or data or both to processor 902 for execution. For example, instructions and data may initially be carried on a magnetic disk of a remote computer such as host 982. The remote computer loads the instructions and data into its dynamic memory and sends the instructions and data over a telephone line using a modem. A modem local to the computer system 900 receives the instructions and data on a telephone line and uses an infra-red transmitter to convert the instructions and data to a signal on an infra-red carrier wave serving as the network link 978. An infrared detector serving as communications interface 970 receives the instructions and data carried in the infrared signal and places information representing the instructions and data onto bus 910. Bus 910 carries the information to memory 904 from which processor 902 retrieves and executes the instructions using some of the data sent with the instructions. The instructions and data received in memory 904 may optionally be stored on storage device 908, either before or after execution by the processor 902.

FIG. 10 illustrates a chip set 1000 upon which an embodiment of the invention may be implemented. Chip set 1000 is programmed to carry out the inventive functions described herein and includes, for instance, the processor and memory components described with respect to FIG. 10 incorporated in one or more physical packages. By way of example, a physical package includes an arrangement of one or more materials, components, and/or wires on a structural assembly (e.g., a baseboard) to provide one or more characteristics such as physical strength, conservation of size, and/or limitation of electrical interaction.

In one embodiment, the chip set 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-word signals (e.g., sound) in real time independently of the processor 1003. Similarly, an ASIC 1009 can be configured to performed specialized functions not easily performed by a general purposed processor. Other specialized components to aid in performing the inventive functions described herein include one or more field programmable gate arrays (FPGA) (not shown), one or more controllers (not shown), or one or more other special-purpose computer chips.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein. The memory 1005 also stores the data associated with or generated by the execution of the inventive steps.

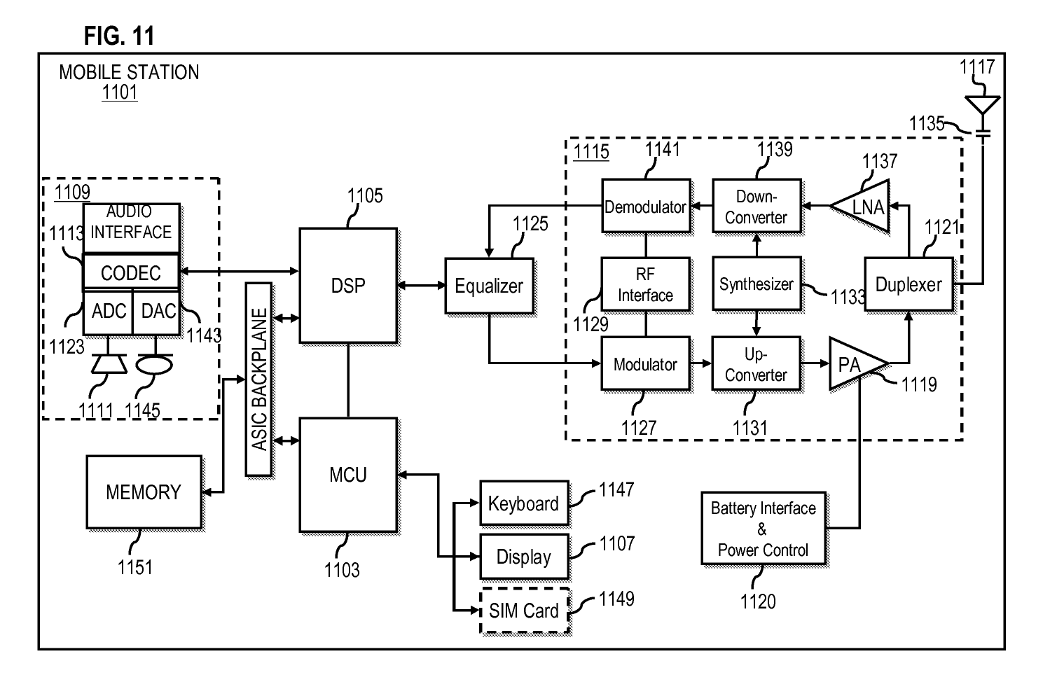

FIG. 11 is a diagram of example components of a mobile station (e.g., handset) capable of operating in the system of FIG. 1, according to one embodiment. Generally, a radio receiver is often defined in terms of front-end and back-end characteristics. The front-end of the receiver encompasses all of the Radio Frequency (RF) circuitry whereas the back-end encompasses all of the base-band processing circuitry. Pertinent internal components of the station include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile station functions. An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies power and converts frequency in order to communicate with a base station, which is included in a mobile communication system, via antenna 1117. The power amplifier (PA) 1119 and the transmitter/modulation circuitry are operationally responsive to the MCU 1103, with an output from the PA 1119 coupled to the duplexer 1121 or circulator or antenna switch, as known in the art. The PA 1119 also couples to a battery interface and power control unit 1120.

In use, a user of mobile station 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In the example embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wireless fidelity (WiFi), satellite, and the like.

The encoded signals are then routed to an equalizer 1125 for compensation of any frequency-dependent impairments that occur during transmission though the air such as phase and amplitude distortion. After equalizing the bit stream, the modulator 1127 combines the signal with a RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1119 to increase the signal to an appropriate power level. In practical systems, the PA 1119 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile station 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1105. A Digital to Analog Converter (DAC) 1143 converts the signal and the resulting output is transmitted to the user through the speaker 1145, all under control of a Main Control Unit (MCU) 1103-which can be implemented as a Central Processing Unit (CPU) (not shown).

The MCU 1103 receives various signals including input signals from the keyboard 1147. The MCU 1103 delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the station. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile station 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable storage medium known in the art. The memory device 1151 may be, but not limited to, a single memory, CD, DVD, ROM, RAM, EEPROM, optical storage, or any other non-volatile storage medium capable of storing digital data.

An optionally incorporated SIM card 1149 carries, for instance, important information, such as the cellular phone number, the carrier supplying service, subscription details, and security information. The SIM card 1149 serves primarily to identify the mobile station 1101 on a radio network. The card 1149 also contains a memory for storing a personal telephone number registry, text messages, and user specific mobile station settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

What is claimed is:

1. An apparatus comprising:
at least one processor; and
at least one memory including computer program code, the memory and the computer program code configured to, with the processor, cause the apparatus to perform at least the following:
initiate modification of a metadata extraction rule based on configuration data; and
extract metadata from a document received in a message using the modified extraction rule.

2. An apparatus of claim 1, wherein the configuration data is associated with one of a plurality of different document-flow based services.

3. An apparatus of claim 1, wherein the processor and the memory are further configured to initiate storage of metadata in the database, wherein the metadata includes at least one of the metadata extracted from the document and message metadata that describes the message in which the document is received, and wherein the message metadata includes information on at least one of a time of delivery, an identifier for a sender or text in a subject line.

4. An apparatus of claim 1, wherein the processor and the memory are further configured to:
initiate modification of a display rule based on the configuration data; and
initiate display of the metadata using the modified display rule

5. An apparatus of claim 1, wherein the processor and the memory are further configured to:
initiate storage of the document and the metadata in a database based on metadata definition data included in the configuration data; and
determine an index to order retrieval of documents from the database based on index data included in the configuration data,
wherein the index data indicates a metadata parameter name and a sort order.

6. An apparatus of claim 1, wherein the processor and the memory are further configured to:
initiate storage of the document and the metadata in a database based on metadata definition data included in the configuration data; and
determine a filter to limit retrieval of documents from the database based on filter data included in the configuration data,
wherein the filter data indicates a Boolean expression including a metadata parameter name.

7. An apparatus of claim 6, wherein the processor and the memory are further configured to
determine a counter to count documents from the database that that are passed by a filter based on counter data included in the configuration data,
wherein the counter data indicates the filter data.

8. An apparatus of claim 1, wherein the extracted metadata includes a value for a document type metadata parameter.

9. An apparatus of claim 8, wherein the extraction of the metadata includes obtaining one or more metadata parameters in the document based on the value for the document type and the configuration data.

10. An apparatus of claim 1, wherein the processor and the memory are further configured to open the document in a form selected from a plurality of forms included in the configuration data, wherein the form presents the document to a user of the apparatus and controls what can be changed in the document by the user.

11. An apparatus of claim 10, wherein opening the document using the form includes opening the document in response to input from the user, wherein the input indicates the document in a list of documents on a display of the apparatus.

12. An apparatus of claim 10, wherein the extracted metadata includes a value for a document type metadata parameter, and the selected form is based, at least in part, on the value for the document type metadata parameter.

13. An apparatus of claim 10, wherein the form modifies the document based on input from a user of the apparatus.

14. An apparatus of claim 13, wherein the processor and the memory are further configured to store the modified document and update a database of the metadata based on the modified document.

15. A system including the apparatus of claim 1, the system further comprising a server host configured to provide at least one of the document or the configuration data.

16. A computer-readable storage medium carrying one or more sequences of one or more instructions which, when executed by one or more processors, cause an apparatus to perform at least the following:
initiate modification of a metadata extraction rule based on configuration data; and
extract metadata from a document received in a message using the modified extraction rule.

17. A computer-readable storage medium of claim 16, wherein the configuration data is associated with one of a plurality of different document-flow based services.

18. A computer-readable storage medium of claim 16, wherein the apparatus is further caused to perform:
initiating storage of the document and the metadata in a database based on metadata definition data included in the configuration data; and
determining at least one of
a filter to limit retrieval of documents from the database based on filter data included in the configuration data,
a counter to count documents from the database that that are passed by a filter based on counter data included in the configuration data, or
an index to order retrieval of documents from the database based on index data included in the configuration data.

19. A method comprising:
transmitting a configuration document that holds configuration data for modifying a metadata extraction rule for extracting metadata from a document for a document-flow based service; and
transmitting a message that includes a document that includes the metadata for the document-flow based service.

20. A method of claim 19, wherein the configuration data includes:
metadata definition data for storage of the document and the metadata in a database;
filter data that indicates a filter to limit retrieval of documents from the database;
counter data that indicates a counter to count documents from the database that are passed by the filter; and
index data that indicates an index to order retrieval of documents from the database.
